(19) United States
(12) Patent Application Publication
(10) Pub. No.: US 2021/0122385 A1
(43) Pub. Date: Apr. 29, 2021

(54) SYSTEMS AND METHODS FOR EMERGENCY BUS PROTECTION IN AN AUTONOMOUS VEHICLE

(71) Applicant: Pony AI Inc., Grand Cayman (KY)

(72) Inventors: Francisco Javier Rovira de la Torre, Fremont, CA (US); Qi Wang, Fremont, CA (US)

(21) Appl. No.: 17/013,211

(22) Filed: Sep. 4, 2020

Related U.S. Application Data
(60) Provisional application No. 62/927,066, filed on Oct. 28, 2019.

(51) Int. Cl. B60W 50/04; B60W 60/00; B60W 50/02

(52) U.S. Cl. CPC B60W 50/04; B60W 50/0205; B60W 60/001

(57) ABSTRACT

A system and method for protecting the bus in an autonomous vehicle are provided. The protecting system can determine, by a vehicle computer, that there is a fault in a first bus of the autonomous vehicle and determine a route of communication for one or more components of the autonomous vehicle that are connected to the first bus. The route of communication in the protecting system can traverse a second bus in the autonomous vehicle.

### CROSS-REFERENCE TO RELATED APPLICATION

This application claims the benefit of U.S. application Ser. 62/927,066, filed Oct. 28, 2019, the content of which is incorporated herein by reference in its entirety.

### FIELD OF THE INVENTION

This disclosure relates to the field of communication between the components of an autonomous vehicle.

### BACKGROUND

A bus is a communication system developed to connect multiple electronic components. A bus is a vehicle has various applications and is widely used in the electronics systems of vehicles. A vehicle may have multiple buses that are dedicated to various electronic systems in the vehicle. For example, a vehicle may have a first bus that is dedicated to the engine control and a second bus that is dedicated to the internal systems of the vehicle. In the case of an autonomous vehicle, a separate autonomous bus may be dedicated to the autonomous electronic components of the autonomous vehicle. One issue for the autonomous bus is that the autonomous electronic components may be rendered inoperable if there is a fault in the autonomous bus. There is a need in the art for a system that allows the autonomous components of an autonomous vehicle to continue to operate when there is a fault in the autonomous bus.

### SUMMARY

The present disclosure includes a system and methods for protecting a bus in an autonomous vehicle. A method includes determining, by a vehicle computer, that there is a fault in a first bus of the autonomous vehicle and determining a route of communication for one or more components of the autonomous vehicle that are connected to the first bus where the route of communication traverses a second bus in the autonomous vehicle. The method may further include determining that there is a fault in a first component of the autonomous vehicle that is connected to the first bus and determining that one or more functions, of the first component, are not being performed. The method may further include performing, by a second component of the autonomous vehicle, which is connected to the first bus, the one or more functions of the first component. The method may further include creating a priority of functions for the one or more components of the autonomous vehicle that are connected to the first bus and selecting the second component based on the priority of functions. The method may further include determining a set of the one or more components that are capable of performing the functions of the first component where the second component is selected from the set. The method may further include determining one or more functions of the second component to stop based on the priority of functions. The one or more components of the autonomous vehicle that are connected to the first bus may be configured to send and receive signals on the route of communication responsive to determining that there is a fault in the first bus. The two or more components, that are connected to the first bus may be configured to send and receive signals from each other where the signals traverse the route of communication.

In an exemplary embodiment, an autonomous vehicle includes a vehicle computer that is configured to determine that there is a fault in a first bus of the autonomous vehicle where the vehicle computer is configured to determine a route of communication for one or more components of the autonomous vehicle that are connected to the first bus where the route of communication traverses a second bus in the autonomous vehicle. The autonomous vehicle is further configured to determine that there is a fault in a first component of the autonomous vehicle that is connected to the first bus and determine that one or more functions, of the first component, are not being performed. The autonomous vehicle further includes a second component of the autonomous vehicle, which is connected to the first bus where the second component is capable of performing the one or more functions of the first component. The vehicle computer is further configured to create a priority of functions for the one or more components of the autonomous vehicle that are connected to the first bus where the vehicle computer is further configured to select the second component based on the priority of functions. The vehicle computer is further configured to determine a set of the one or more components that are capable of performing the functions of the first component where the second component is selected from the set. The vehicle computer may be further configured to determine one or more functions of the second component to stop based on the priority of functions. The one or more components of the autonomous vehicle that are connected to the first bus may be configured to send and receive signals on the route of communication responsive to the determination that there is a fault in the first bus. The two or more components that are connected to the first bus may be configured to send and receive signals from each other where the signals traverse the route of communication.

Another general aspect is a computer readable storage medium in an autonomous vehicle having data stored therein representing a software executable by a computer, the software comprising instructions that, when executed, cause the autonomous vehicle to determine that there is a fault in a first bus of the autonomous vehicle and determining a route of communication for one or more components of the autonomous vehicle that are connected to the first bus where the route of communication traverses a second bus in the autonomous vehicle. The software may further cause the autonomous vehicle to determine that there is a fault in a first component of the autonomous vehicle that is connected to the first bus and determine that one or more functions, of the first component, are not being performed. The software may further cause a second component of the autonomous vehicle, which is connected to the first bus to perform the one or more functions of the first component. The software may further cause the autonomous vehicle to create a priority of functions for the one or more components of the autonomous vehicle that are connected to the first bus and select the second component based on the priority of functions. The software may further cause the autonomous vehicle to determine a set of the one or more components that are capable of performing the functions of the first component where the second component is selected from the set. The software may further cause the autonomous vehicle to determine one or more functions of the second component to stop based on the priority of functions. The one or more components of the autonomous vehicle that are connected to the first bus may be configured to send and receive signals on the route of communication responsive to determining that there is a fault in the first bus.

### BRIEF DESCRIPTION OF THE DRAWINGS

FIG. 1 is a schematic illustrating the components that may be used in a system for bus protection in an autonomous vehicle.

FIG. 2A is a schematic illustrating the communication of nodes on a bus.

FIG. 2B is a schematic illustrating an autonomous vehicle computer that may be used in a system for bus protection in an autonomous vehicle.

FIG. 3 is a schematic illustrating a bridge that connects two bus systems.

FIG. 4 is a schematic illustrating a failure in a bus.

FIG. 5 is a schematic illustrating a fault in a component attached to a bus.

FIG. 6 is a schematic illustrating a drive by wire component attached to a bus.

FIG. 7 is a flow diagram of a process for emergency bus protection.

FIG. 8 is an illustration of the electronic control components that may be connected to the bus in an autonomous vehicle.

FIG. 9 is a schematic illustrating the computing components that may be used to implement various features of embodiments described in the present disclosure.

### DETAILED DESCRIPTION

The disclosed subject matter is a system for protecting the operation of an autonomous bus and the components connected to the autonomous bus of an autonomous vehicle. The autonomous bus may be susceptible to a failure. For example, the circuit path in a bus may be severed through an electrical malfunction or a physical break in the autonomous bus. In another example, the autonomous bus may have a short, disabling all communication on the autonomous bus. In another example, the autonomous bus is spammed by one or more vehicle computers connected to the autonomous bus. The autonomous bus, as it is spammed with excess data, is not capable of transmitting additional data. In another example, the autonomous bus may lose power. In another example, a component that connects the autonomous bus to the rest of the autonomous vehicle may have a fault, which renders the autonomous bus inoperable. In addition to failures on the autonomous bus, the failure may occur on various components in the autonomous bus and render the system inoperable.

The disclosed subject matter is a system that allows an autonomous vehicle to continue operating when there is a failure in the autonomous bus or a failure in a component of the autonomous bus. The system, which comprises the operating components of the autonomous bus, is configured to determine that there is a failure that prevents the autonomous bus from working. The system determines a new route of communication for the components of the autonomous bus by bypassing a failure.

Components, such as computers, connected to the autonomous bus are configured to replace the functions of failing components. In various cases of faults, the autonomous vehicle may be incapable of functioning, even in a diminished state, without the function of a faulting component. In such cases, the function of the faulting component is replaced by another component. The system is configured to determine if the function of the faulting component should be replaced by another component. The system is further configured to determine a set of components that are capable of replacing the function of the faulting component. The system is further configured to determine a priority of the functions of the faulting component and the functions of components that are capable of replacing the functions of the faulting component. The system is configured to select a component to replace the function of the faulting component based on the priority. In one embodiment, the component of lowest priority, which is capable of replacing the function of the faulting component, is selected to replace the function of the faulting component.

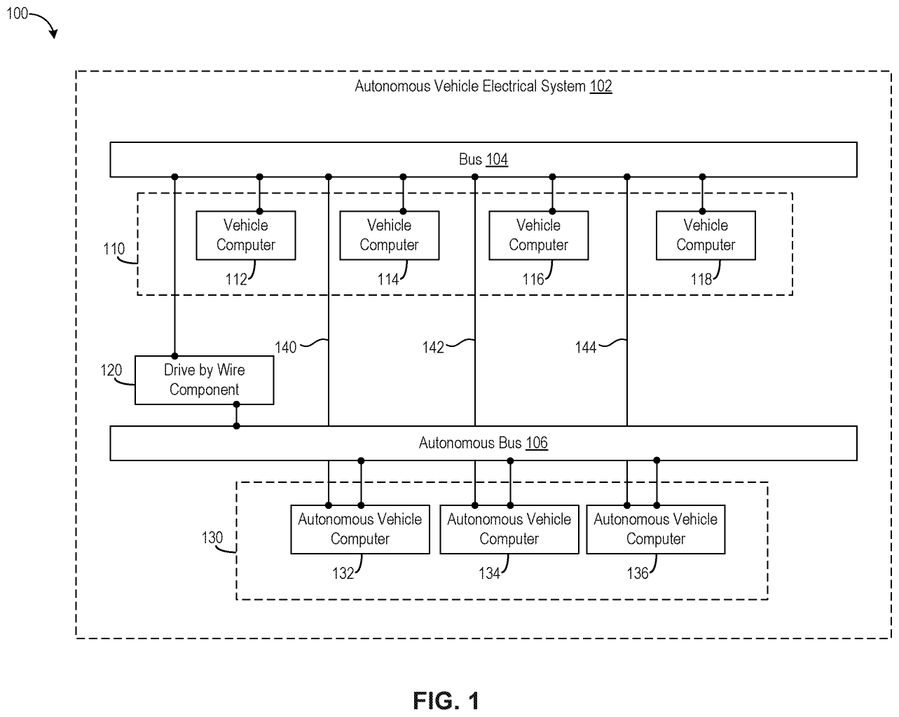

Referring to FIG. 1, FIG. 1 is a schematic 100 of the autonomous vehicle electrical system 102 that is configured to protect an autonomous bus in an emergency. The autonomous vehicle electrical system 102 includes one or more vehicle bus networks. The vehicle bus network facilitates the communication of electrical components in the autonomous vehicle. Electrical components such as a multitude of vehicle computers 110 are connected to the vehicle bus network. Signals from the multitude of vehicle computers 110 and electrical components of the autonomous vehicle are transmitted through the vehicle bus network.

A common protocol for a vehicle bus network is a control area network (“CAN Bus”). A CAN Bus is a vehicle bus network that is configured to operate under the CAN protocol. The CAN protocol may control or specify the arrangement of wires that connect the components of the CAN bus. The CAN protocol further specifies the form of transmission, which includes an identification signal that differentiates the various components that are connected to the CAN bus. The CAN protocol also includes an arbitration system, whereby signals that are sent simultaneously are prioritized. The signal that is determined to be higher in priority is transmitted before signals that are lower in priority.

In various embodiments, a vehicle bus network other than a CAN bus may be implemented as part of the autonomous vehicle electrical system 102. The autonomous vehicle electrical system 102 includes a bus 104 and an autonomous bus 106. The bus 104 may have a multitude of vehicle computers 110 connected to the bus 104. The multitude of vehicle computers 110 may control various systems in the autonomous vehicle such as the engine controller or the entertainment system.

The multitude of vehicle computers 110 may communicate with each other by transmitting and receiving signals through the bus 104. Signals sent through the bus 104 may include an identification of the vehicle computer along with a priority for the signal. For example, a signal from vehicle computer 112 may include an identification of vehicle computer 112 along with the priority of the signal in addition to a communication. Each of the multitude of vehicle computers 110 may receive the signal that was sent by vehicle computer 112. For example, a vehicle computer 114, vehicle computer 116 and vehicle computer 118 may each receive a signal that is transmitted to the bus 104 by vehicle computer 112. The multitude of vehicle computers 110 may be configured to respond in various ways to signals received from the bus 104. For example, vehicle computer 114 may be configured to activate an actuator in response to receiving a signal from vehicle computer 112 while vehicle computer 116 may be configured to save all signals that originate from vehicle computer 112. At the same time, vehicle computer 118 may be configured to ignore all signals from vehicle computer 112.

Any component that is connected to the bus may send signals through the bus 104 and receive signals from the bus. For example, in the embodiment shown in FIG. 1, a drive by wire component 120 may receive signals from a multitude of vehicle computers 110. The drive by wire component 120 may be configured to send driving control instructions, that when executed, operate the driving controls of the autonomous vehicle. As the drive by wire component 120 sends driving control instructions to operate the driving controls of the autonomous vehicle, the drive by wire component 120 may also receive signals. As shown in FIG. 1, the drive by wire component is connected to the bus 104 and to the autonomous bus 106. The drive by wire component 120 may receive signals from components connected to the autonomous bus 106 and relay those signals to the bus 104 to be executed by components connected to the bus 104.

Like the multitude of vehicle computers 110, the multitude of autonomous vehicle computers 130 may communicate with each other by transmitting signals through a bus. As shown in FIG. 1, the multitude of autonomous vehicle computers 130 are connected to an autonomous bus 106. The multitude of autonomous vehicle computers 130 may determine, for example, the instructions for driving controls for the autonomous vehicle. The instructions for driving controls may be transmitted to the drive by wire component 120, where the signals are processed and relayed to the various driving controls that operate the autonomous vehicle. In one implementation, the autonomous vehicle computer 132 may determine from sensor data, that various objects are around the autonomous vehicle. The autonomous vehicle computer 132 may transmit the object locations to autonomous vehicle computer 134 through the autonomous bus 106. The autonomous vehicle computer 134 may determine the course of action for the autonomous vehicle, base on object location data from autonomous vehicle computer 132. Autonomous vehicle computer 134 may transmit the course of action of the autonomous vehicle to autonomous vehicle computer 136 through the autonomous bus 106, whereby autonomous vehicle computer 136 determines the driving controls instructions based on the course of action. The autonomous vehicle computer 136 may transmit the driving control instructions to the drive by wire component 120, which processes and relays the driving control instructions to the various driving controls of the autonomous vehicle.

Failures in the autonomous bus 106 or faults in components that connect the autonomous bus 106 to the bus, such as the drive by wire component 120, may prevent the instructions from the multitude of autonomous vehicle computers 130 from being transmitted out to the driving controls. Further, a fault in the autonomous bus 106 may prevent the multitude of autonomous vehicle computers 130 from communicating with each other. To navigate around failures that prevent communication within the multitude of autonomous vehicle computers 130 and faults that prevent driving control instructions from being transmitted to the driving controls, one or more of the multitude of autonomous vehicle computers 130 is connected to the bus 104 as well as the autonomous bus 106.

As shown in FIG. 1, the autonomous vehicle computer 132 is connected to the bus 104 through connection 140. Connections 140, 142, and 144 connect the multitude of autonomous vehicle computers 130 to the bus 104. In the case of a fault in the autonomous bus 106, the multitude of autonomous vehicle computers 130 may be configured to transmit signals directly to various components of the autonomous vehicle electrical system 102 without going through the autonomous bus 106. For example, autonomous vehicle computer 132 may transmit a signal to autonomous vehicle computer 134 through a new route of communication based on determining that there is a fault in the autonomous bus 106. The new route of communication may include a connection, such as connection 140, to another bus. The new route of communication may include a connection to various components that relay signals to a destination.

The various components of the autonomous vehicle electrical system 102, including the multitude of vehicle computers 110 and the multitude of autonomous vehicle computers 130, may be further configured to take over the functions of faulting components in response to determining that a component has a fault. For example, the autonomous vehicle computer 132 may take over the functions of the drive by wire component 120 in response to a fault in the drive by wire component 120. A fault in the drive by wire component 120 may also result in the multitude of autonomous vehicle computers 130 using a new route of communication to transmit signals to the rest of the autonomous vehicle electrical system 102.

Various components of the autonomous vehicle electrical system 102 may be configured to take over functions of other components. The various components of the autonomous vehicle electrical system 102 may be further configured to suspend functions of lower priority functions as higher priority functions take precedence. For example, a vehicle computer that controls the entertainment system of the autonomous vehicle may suspend entertainment functions as the vehicle computer takes over the functions of a higher priority such as the drive by wire component 120.

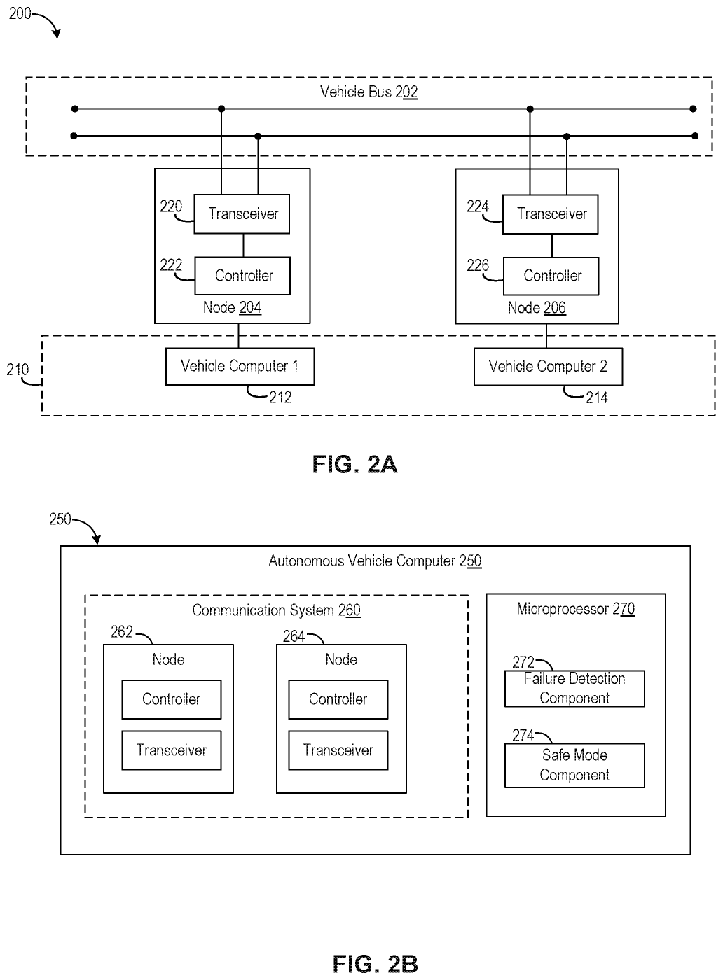

Referring to FIG. 2A, FIG. 2A is a schematic 200 illustrating the communication of nodes on a vehicle bus 202. In one embodiment, the vehicle bus 202 shown in FIG. 2A is capable of operating a CAN protocol. A bus that is compliant with a CAN protocol has two wires. Two or more nodes are connected to the vehicle bus 202. The two or more nodes may be connected to one or more vehicle components. A multitude of vehicle computers 210 may communicate with each other by sending and receiving signals through nodes that are connected to the vehicle bus 202.

Node 204 is an example of a node that has a processor and memory that facilitate the transmission and reception of signals through the vehicle bus 202. Signals may be generated at vehicle computer 212. The controller 222 converts the signal from vehicle computer 212 into a format for transmission on the vehicle bus 202. If the controller 222 is sending a signal over a CAN bus, the signal may include a priority identifier that establishes a priority for the transmission, an identifier that identifies that vehicle component that is sending the signal, data for a message within the signal, and an acknowledgement that may be overwritten by each respective node that receive the signal.

The signal, generated by the controller 222, may be transmitted to a transceiver 220. The transceiver 220 is the component of the node 204 that directly connects to the vehicle bus 202. The transceiver 220 may be in electrical communication with the vehicle bus 202. If the vehicle bus 202 is compliant with one or more CAN protocols, the vehicle bus 202 will include two or more wires which are connected to the transceiver 220. The transceiver 220 transmits the signals created by the controller 222 to the vehicle bus 202. All nodes connected to the vehicle bus 202 may receive the transmission by a transceiver 220 on the vehicle bus 202.

The transceiver 224 for node 206 receives transmission signals on the vehicle bus 202 and relays the signals to the controller 226. The controller 226 is configured to determine the priority identifier and respond to the highest priority signals before responding to the lower priority signals. The controller 226 may be configured to ignore or respond to signals based on the content of the signals. Based on the signal, the controller 226 may transmit the data of a signal to the vehicle computer 214. The vehicle computer 214 may respond to the data received from the controller 226 in various ways. In one example, the vehicle computer 214 may activate an actuator based on the signal received by the transceiver 224.

Referring to FIG. 2B, FIG. 2B is a schematic illustrating an autonomous vehicle computer 250 that may be used in a system for emergency bus protection in an autonomous vehicle. The autonomous vehicle computer 250 includes a communication system 260 and a microprocessor 270. The communication system 260 of the autonomous vehicle computer 250 receives and sends signals through connections to one or more vehicle buses 202. The communication system 260 includes one or more nodes that are connected to a vehicle bus 202. As shown in FIG. 2B, the autonomous vehicle computer 250 includes two nodes that may be each connected to a vehicle bus 202. For example, node 262 may be connected to a different vehicle bus 202 than node 264.

In one embodiment, node 262 is connected to an autonomous bus 106 that connects a multitude of autonomous vehicle computers 130 to each other. Node 264 is connected to a bus that is connected to the multitude of vehicle computers 110. Node 262 is used primarily by the autonomous vehicle computer 250. If there is a failure or fault that requires the autonomous vehicle computer 250 to communicate by a new route of communication, node 264 may be used to communicate by a new route of communication.

The microprocessor processes data for the autonomous vehicle computer 250. The microprocessor includes a fault detection component 272 and a safe mode component 274. The fault detection component 272 is configured to determine that there is a fault in the bus for which the communication system 260 is connected. The fault detection component 272 may detect that there is a fault in one or more ways. In one example, the fault detection component 272 detects that there is a fault by sensing a lack of data received from the bus for a set period of time. In one implementation, the fault detection component 272 determines that there is a fault in the vehicle bus 202 when data is not received by node 262 for more than five seconds.

The fault detection component 272 may also determine that there is a fault in a component of the autonomous vehicle electrical system 102. In one example, the fault detection component 272 determines that there is a fault in a component when data from a specific component is not received for a set period of time. In another example, the fault detection component 272 determines that there is a fault when a component transmits erroneous data to the communication system 260. The fault detection component 272 may transmit signals to various components of the autonomous vehicle electrical system 102 to verify that the components are operational after a fault is detected in a bus or another component.

Once a fault is detected, the safe mode component 274 may activate a safe mode for the autonomous vehicle computer 250. The safe mode may specify various changes to the operation of the autonomous vehicle computer 250 based on the fault or failure that was detected by the fault detection component 272. In one example, the safe mode component 274 specifies a new route of communication for the communication system 260. The new route of communication may require the use of node 264 instead of node 262 or vice versa. The new route of communication may include the use of a different recipient node of another autonomous vehicle computer 250. The safe mode component 274 may cause the autonomous vehicle component 250 to send a safe mode signal to various other computers of the autonomous vehicle electrical system 102.

Also, once a failure is detected, the safe mode component 274 may determine that the functions of the autonomous vehicle computer 250 should change or be modified to compensate for the loss of functionality of a faulting component. For example, the autonomous vehicle computer 250 may perform one or more functions of the drive by wire component 120 after determining that there is a fault in the drive by wire component 120. The safe mode component 274 may communicate with other autonomous vehicle computers 250 to determine which autonomous vehicle computer 250 should perform the functions of a faulting component. In one embodiment, the safe mode component 274 determines a set of autonomous vehicle computers 250 that are capable of performing the functions of the faulting component. After the set of autonomous vehicle computers 250 are determined, the safe mode component 274 determines a priority of functions of the set of autonomous vehicle computers 250. In one implementation, the autonomous vehicle computer 250 within the set that is capable of performing the functions of the faulting component that has the lowest priority is selected by the safe mode component 274 to perform the functions of the faulting component. In one implementation, the autonomous vehicle computer 250 that is selected to perform the functions of the faulting component ceases its original functions. In various implementations, the autonomous vehicle computer 250 may receive a new priority setting equal or greater than the faulting component that it is replacing.

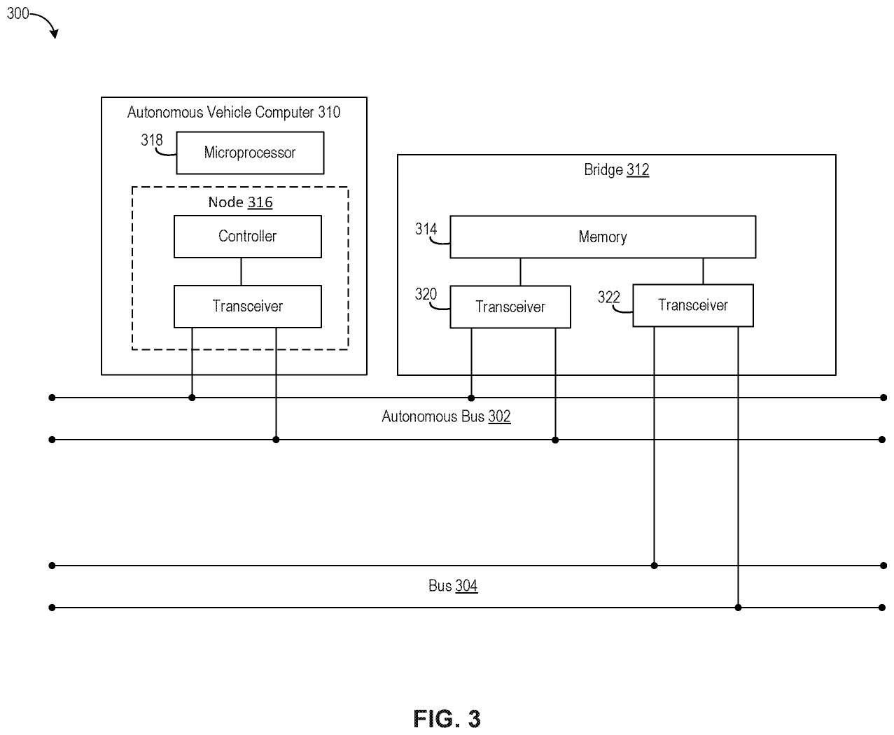

Referring to FIG. 3, FIG. 3 is a schematic 300 illustrating a bridge 312 that connects two buses. The bridge 312 allows components in the autonomous vehicle electrical system 102 to send and receive signals in between each other. As opposed to the multitude of autonomous vehicle computers 130 shown in FIG. 1, which are connected to two buses, the bridge 312 allows components that are connected to only one bus to transmit a signal to be relayed from one bus to another bus. The bridge 312 also allows the multitude of multitude of autonomous vehicle computers 130 to transmit a signal from the autonomous bus 106 to the bus 104 without being directly connected to the bus 104.

The bridge includes a memory 314, a transceiver 320 connected to an autonomous bus 302, and a transceiver 322 may be connected to a bus 304. A signal that is transmitted from a node 316 of an autonomous vehicle computer 310 may be relayed by the bridge from the autonomous bus 302 to the bus 304. The microprocessor 318 of the autonomous vehicle computer 310 may configure the node to transmit a signal through the autonomous bus 302 to the bus 304 through the bridge 312. Signals may be transmitted to the autonomous bus 302 by the transceiver of the node 316 of the autonomous vehicle computer 310. The transceiver 320 of the bridge 312 may receive the signal from the autonomous bus 302. The signal may be relayed through a memory 314 to the transceiver 322 and transmitted to the bus 304.

The bridge 312 allows autonomous vehicle computers 310 to be connected to only one bus and use a new route of communication to send signals to components on a different bus. If a fault is detected on the autonomous bus 302, the autonomous vehicle computer 310 may transmit signals via a new route of communication using one or more bridges 312. Alternatively, as shown in FIG. 2B and FIG. 1, the autonomous vehicle computer 250 may be connected to two buses and transmit signals to a second bus directly.

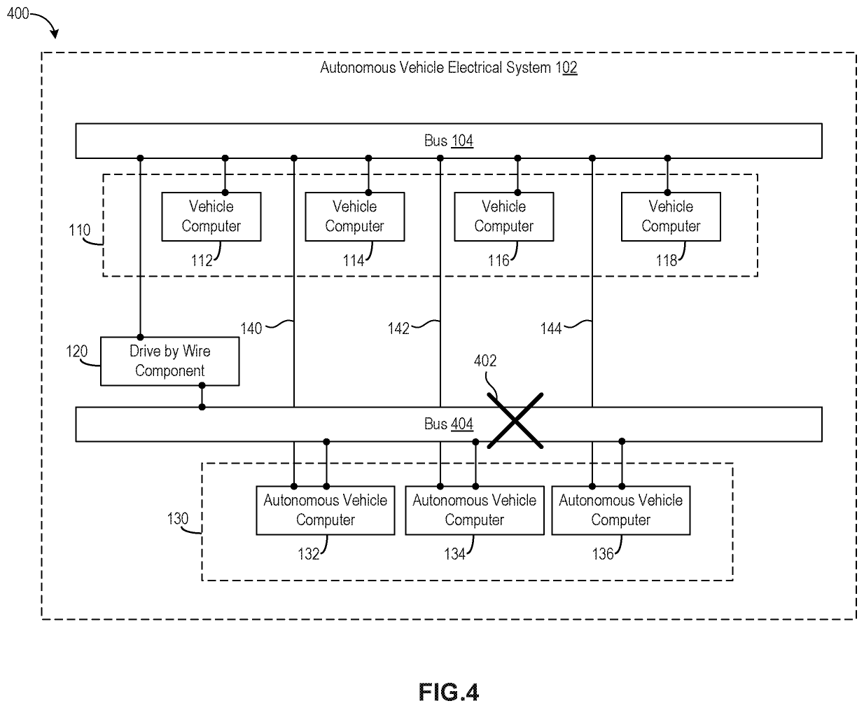

Referring to FIG. 4, FIG. 4 is a schematic 400 illustrating a fault 402 in a bus 404. The fault 402 is in the bus 404. The fault 402 may have various causes including being physically severed and being spammed by a faulting component. The fault 402 may render the bus 404 inoperable and prevent communication signals from being sent and received through the bus 404. The fault 402 could prevent the multitude of autonomous vehicle computers 130 from communicating with each other. The fault 402 may also prevent the multitude of autonomous vehicle computers 130 from communicating signals to the drive by wire component 120. Thus, a fault in the bus 404 could render all autonomous functions of the autonomous vehicle inoperable.

The fault detection component 272 of one or more of the multitude of autonomous vehicle computers 130 may detect that the fault 402 exists. In one example of detecting the fault 402, the fault detection component 272 determines that the fault 402 exists in the bus 404 after not receiving any data through the bus 404 for a set period of time, such as five seconds. The fault detection component 272 may also determine that the fault 402 exists by measuring a change in the resistance of the bus 404 which could indicate that the bus 404 has been severed. The fault detection component 272 may determine that the fault 402 exists by not receiving a response to test signals that are sent through the bus 404.

In response to determining that the fault exists in the bus 404, the components of the autonomous vehicle electrical system 102 may enter a safe mode. In one implementation, the safe mode may determine that the functioning components of the autonomous vehicle electrical system 102 reduce activity to conserve bandwidth of the bus 104 that is still functioning. The fault 402, necessarily reduces the available bandwidth of the autonomous vehicle electrical system 102 because the fault reduces the number routes of communication that go through the bus 404. Thus, the safe mode may reduce the amount of data being transmitted for the purpose of saving bandwidth.

For example, the safe mode component 274 of autonomous vehicle computer 132 may determine a new route of communication in response to detecting the fault 402. The new route of communication for the autonomous vehicle computer 132 may be through connection 140, which goes through bus 104. Likewise, the autonomous vehicle computer 134 and autonomous vehicle computer 136 may use connections 142 and 144 to communicate with the multitude of autonomous vehicle computers 130.

The fault 402 may render the drive by wire component 120 inoperable if the drive by wire component 120 is not accessible with the bus 404. The safe mode component 274 of one or more of the autonomous vehicle computers 130 may determine one or more autonomous vehicle computers to perform the functions of the drive by wire component 120. Various criteria may be used to determine which autonomous vehicle computer is selected to perform the functions of the drive by wire component 120. In one embodiment, the autonomous vehicle computer 250 that performs the functions of the drive by wire component 120 is selected based on the priority of the functions of all autonomous vehicle computers.

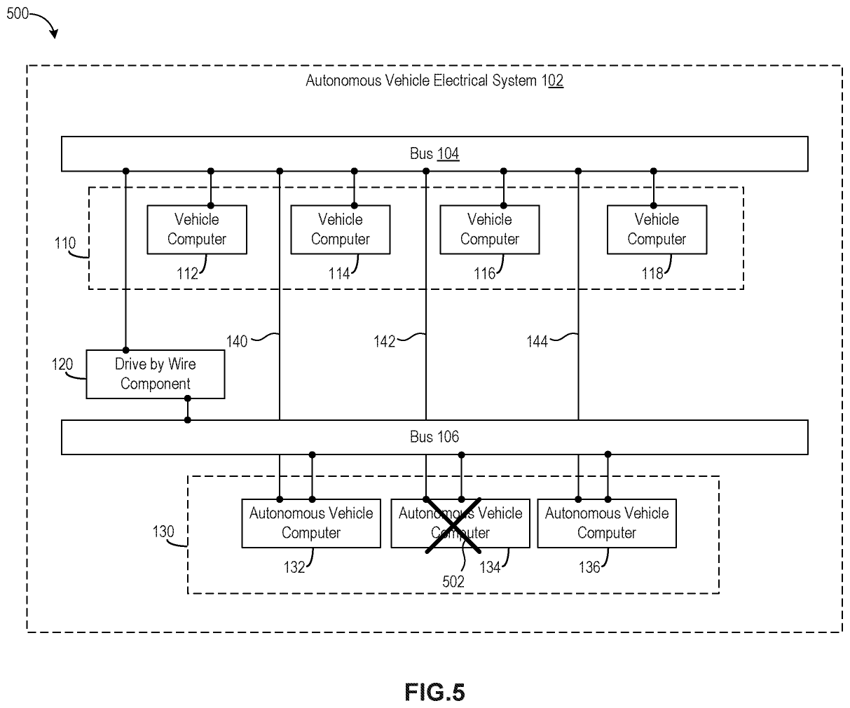

Referring to FIG. 5, FIG. 5 is a schematic 500 illustrating a fault 502 in an autonomous vehicle computer 134. The fault in the autonomous vehicle computer 134 may be caused by a malfunction within the autonomous vehicle computer 134 or a malfunction from outside the autonomous vehicle computer 134 that results in erroneous functions of the autonomous vehicle computer 134. If the functions of the autonomous vehicle computer 134 are necessary for the autonomous operation of the vehicle, the fault 502 will prevent the autonomous operation of the vehicle.

The fault detection component 272 of the multitude of the autonomous vehicle computers 130 may be configured to determine that one or more components of the autonomous vehicle electrical system 102 are faulting. The fault detection component 272 may determine that a component is faulting in various ways. In one embodiment, the fault detection component 272 determines that a component is faulting by finding that the component has not sent data for a set period of time. In various embodiments, the fault detection component 272 determines that a component is faulting by finding that the data sent from the component is erroneous. Erroneous data is data that is incorrect in some way. Examples of erroneous data are data that may be in the wrong format or may be sent at the wrong time. Erroneous data may be random noise that is output by the component.

Once the fault detection component 272 determines there is a fault 502, the safe mode component 274 may activate a safe mode in one or more components of the autonomous vehicle electrical system 102. The safe mode component 274 may select an autonomous vehicle computer 250 to take over the functions of the component experiencing the fault 502. In one embodiment, one or more of the multitude of autonomous vehicle computers 130 are configured to perform the functions of one or more faulting components. For example, the autonomous vehicle computer 132 may take over the functions of autonomous vehicle computer 134 that is experiencing a fault. When the autonomous vehicle computer 132 takes over the functions of a faulting component, the autonomous vehicle computer 132 may cease one or more of the original functions of the autonomous vehicle computer 132. The one or more functions that are ceased may be determined by the safe mode component 274. The safe mode component 274 may be configured to cease non-essential functions of the autonomous vehicle computer 132 in response to entering a safe mode or performing the functions of a faulting component.

The autonomous vehicle electrical system 102 may be configured to isolate the fault when more than one autonomous vehicle computer is exhibiting erroneous behavior. In various cases, the erroneous function of an autonomous vehicle computer 134 is the result of a fault in another component. For example, if the autonomous vehicle computer 136 processes data from autonomous vehicle computer 134, a fault in autonomous vehicle computer 134 may be the result of erroneous data output from autonomous vehicle computer 136. The fault detection component 272 of the multitude of autonomous vehicle computers 130 may be configured to isolate a fault to the component that is damaged. The isolation of a fault 502 may be done in various ways. In one embodiment, a fault 502 is isolated by transmitting test data to components that are outputting erroneous data. The test data may require a component that receives the test data to respond in a way that tests the functionality of the component. Components that respond correctly to the test data may be deemed to be fully functional. Alternatively, components that do not respond to the test data correctly may be deemed to have a fault.

The purpose of isolating the faulting component is to open the possibility to salvage the correctly functioning components. The correctly functioning components may be configured to change their functionality, such that the faulting component does not adversely affect the correctly functioning component. In one example, where autonomous vehicle computer 136 receives data from autonomous vehicle computer 134, a fault in autonomous vehicle computer 134 may cause the autonomous vehicle computer 136 to generate erroneous data. If autonomous vehicle computer 136 changes its functionality to accept data from a new route of communication, such as accepting data from autonomous vehicle computer 132, the autonomous vehicle computer 136 may be salvaged. Similarly, components that are rendered inoperable because of a fault in an autonomous bus 106 may be salvaged by changing the route of communication of the component. In some cases, the route of communication of a component and the functionality of a component may be modified to salvage the component.

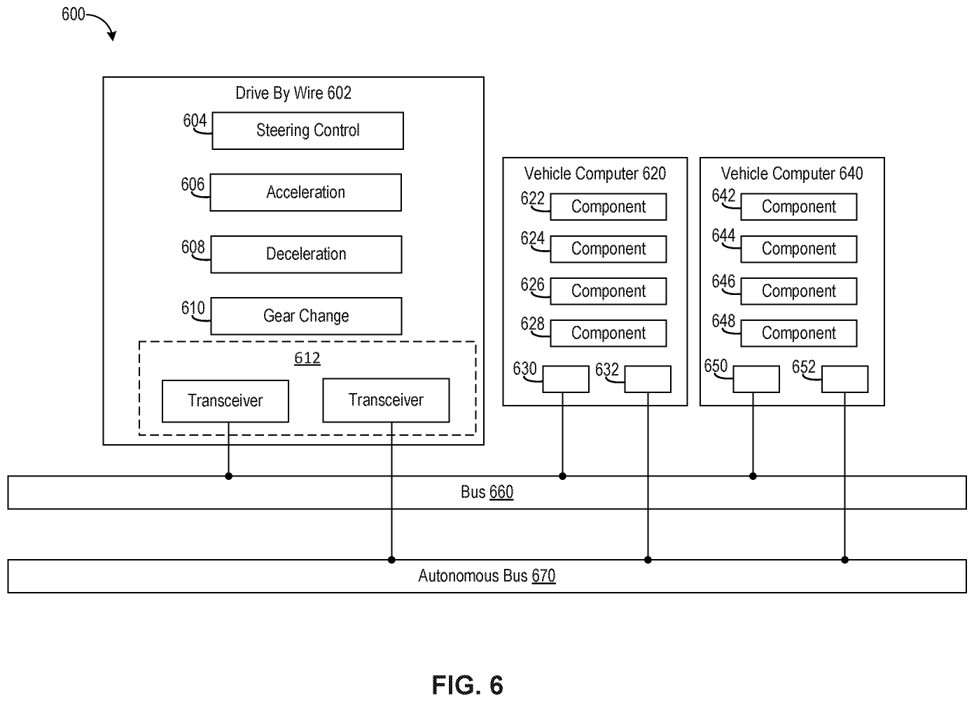

Referring to FIG. 6., FIG. 6 is a schematic 600 illustrating a drive by wire component 602 attached to a bus. The drive by wire component 602 receives driving control instructions from one or more autonomous vehicle computers. The drive by wire component 602 converts the driving control instructions into executable signals and transmits the signals to one or more driving controls.

The driving controls include a steering control 604, an acceleration 606, a deceleration 608, a gear change 610, and one or more transceivers 612. The steering control 604 changes the direction of the autonomous vehicle and can be operated by a steering actuator under control of the drive by wire component 602. The acceleration 606 driving control is a control that increases the velocity of the autonomous vehicle. In an exemplary embodiment, the drive by wire component 602 controls the acceleration 606 of the autonomous vehicle by transmitting signals to an electronic throttle control. The deceleration 608 driving control is a control that decreases the velocity of the autonomous vehicle. In an exemplary embodiment, the drive by wire component 602 controls the deceleration 608 by transmitting signals to a brake by wire system. The gear change 610 driving control changes the gear ratio of the autonomous vehicle if the autonomous vehicle has multiple gear ratios. In an exemplary embodiment, the drive by wire component 602 controls the gear change through a shift by wire system.

Instructions for the driving controls are received by the one or more transceivers 612. The instructions for the driving controls are transmitted to the one or more driving controls of the autonomous vehicle by the one or more transceivers 612 after the instructions for the driving controls are received. In one embodiment, also shown in FIG. 6, the one or more transceivers 612 include two transceivers. Each transceiver is connected to a different bus. One transceiver is connected to an autonomous bus 670. The other transceiver is connected to a bus 660. The instructions for the driving controls are received by the transceiver that is connected to the autonomous bus 670. The multitude of autonomous vehicle computers 130 determine the driving control instructions and transmit the driving control instructions to the drive by wire component 602. The instructions for the driving controls may be received by a transceiver of the drive by wire component that is connected to the autonomous bus 670. The instructions of the driving controls may be processed by the components of the drive by wire component to send the instructions to the various driving controls. In various embodiments, the drive by wire component 602 determines the driving controls for which each instruction for driving control will be sent. The drive by wire component 602 transmits each instruction for driving controls to the respective driving control of the autonomous vehicle via the bus 660. Thus, the drive by wire component 602 continuously receives instructions for driving controls from the autonomous bus 670 and transmits processed instructions for driving controls to the bus 660.

In the event of a fault in the drive by wire component 602, one or more vehicle components may take over the processes of the drive by wire component 602 in response to the fault. In one embodiment, the one or more vehicle computers, such as vehicle computer 620 and vehicle computer 640, may be configured to take over the functions of the drive by wire component 602. For example, vehicle computer 620 may have versatile components that can take over the functions of other vehicle computers. The versatile components of vehicle computer 620 include component 622, component 624, component 626, and component 628. The versatile components of the vehicle computer 620 may be configured to perform the functions of faulting components. In the case that there is a fault in the drive by wire component 602, the versatile components of the vehicle computer 620 may perform the functions of the various components of the drive by wire component 602. For example, component 622 may perform the functions of the steering control 604, component 624 may perform the acceleration 606 function, component 626 may perform the deceleration 608 functions, and component 628 may perform the gear change 610 functions. Similarly, component 642, component 644, component 646, and component 648 of vehicle computer 640 may perform the various driving control functions of the drive by wire component 602 if there is a fault in the drive by wire component 602.

In various embodiments, vehicle computer 620 and vehicle computer 640 may split the work load of performing the functions of the drive by wire component 602. For example, the steering control 604 may be performed by component 622, and acceleration may be performed by component 624, the deceleration 608 control may be performed by component 642, and the gear change 610 control may be performed by component 644. The purpose of splitting the work load of the drive by wire component 602 between two vehicle computers may be to allow the two vehicle computers to maintain the original functions of the two vehicle computers in addition to performing the functions of the drive by wire component 602.

The one or more vehicle computers that perform the functions of the drive by wire component 602 may be connected to both the autonomous bus 670 and the bus 660. For example, the vehicle computer 620 has a transceiver 632 that is connected to the autonomous bus 670 and a transceiver 630 that is connected to the bus 660. Likewise, vehicle computer 640 has a transceiver 652 that is connected to the autonomous bus 670 and a transceiver 650 that is connected to the bus 660. By being connected to both the autonomous bus 670 and the bus 660 the one or more vehicle computers may process the instructions for the driving controls and transmit the processed instructions for the driving controls to the various driving controls of the autonomous vehicle.

In various embodiments, the functions of the drive by wire component 602 may be divided into processing the instructions of the driving controls and transmitting the processed instructions for the driving controls. If the one or more vehicle computers that perform the functions of the drive by wire component 602 are not connected to the bus 660, they cannot transmit the instructions for the driving controls directly to the driving controls. The vehicle computer that processes the instructions for the driving controls may transmit the processed instructions to another vehicle computer, whereby the processed instructions for the driving controls are relayed to the driving controls. For example, the versatile components of vehicle computer 620 may process the instructions for the driving controls. The processed instructions for the driving controls may be transmitted from the vehicle computer 620 to vehicle computer 640. Vehicle computer 640 may relay the processed instructions for the driving controls to the various driving controls.

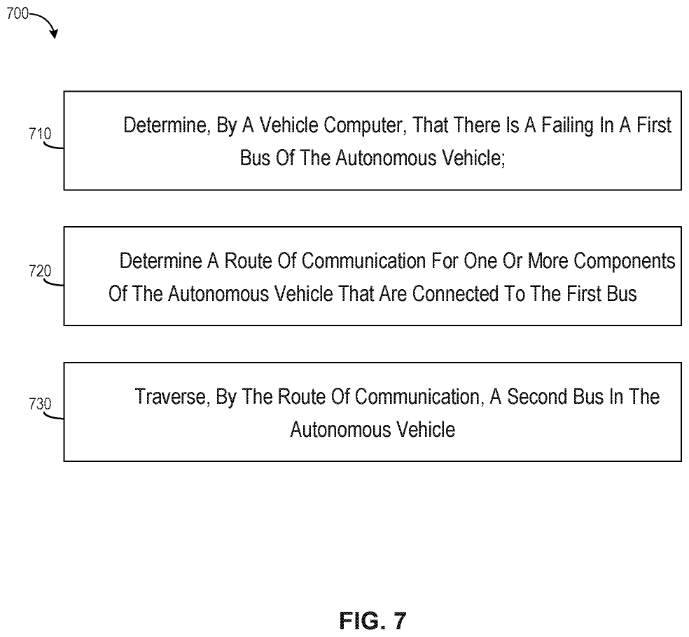

Referring to FIG. 7, FIG. 7 is a flow diagram of a process 700 for emergency bus protection. The process 700 allows the autonomous vehicle electrical system 102 to continue operating when there are faults within the autonomous vehicle electrical system 102. At step 710, the autonomous vehicle electrical system 102 may determine, by an autonomous vehicle computer 250, that there is a fault in a first bus of the autonomous vehicle. The fault in the first bus of the autonomous vehicle may be detected by the fault detection component 272 of an autonomous vehicle computer 250. The fault detection component 272 may detect the fault in the first bus in various ways. For example, the fault detection component 272 may detect a fault by determining that no data was received from the first bus or a set amount of time, such as five seconds. In another example, the fault detection component 272 may detect a fault in the first bus by determining that erroneous data is being received from the first bus. Additionally, the fault detection component may determine that one or more components of the autonomous vehicle are experiencing faults.

At step 720, the autonomous vehicle electrical system 102 may determine a route of communication for one or more components of the autonomous vehicle that are connected to the first bus. The route of communication may go around the fault. The route of communication may be determined by the safe mode component 274 of the autonomous vehicle computer 250. The safe mode component 274 may determine the route of communication in various ways. For example, the safe mode component 274 may transmit test signals to various components of the autonomous vehicle electrical system 102. The test signals may be used to determine the connections in the autonomous vehicle electrical system 102 that are operational.

At step 730, the safe mode component 274 may determine how to traverse, by the route of communication, a second bus in the autonomous vehicle. The route of communication between two components that are connected to the first bus of the autonomous vehicle may begin communicating by a route of communication that traverses a second bus. The route of communication may be used to send a safe mode signal to components in the autonomous vehicle electrical system 102. The safe mode in the autonomous vehicle electrical system 102 may instruct components to cease non-essential functions to save bandwidth in the second bus. The safe mode may also lower the workload for components that take over the functions of components that were taken offline by the fault in the first bus.

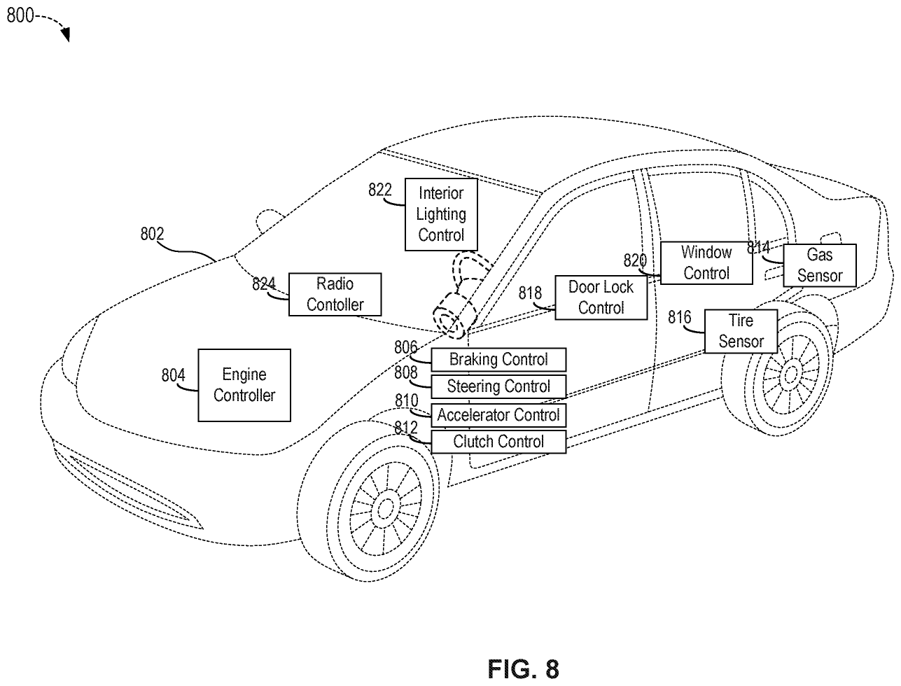

Referring to FIG. 8, FIG. 8 is an illustration 800 of the electronic control components that may be connected to the bus 104 in an autonomous vehicle 802. All components that are connected to the autonomous vehicle electrical system 102 may be connected to one or more buses. The components may transmit signals through the buses or receive signals from the buses. In the event of a fault in the autonomous vehicle electrical system 102, the components may transmit and/or receive signals by a new route of communication that includes a second bus. The components shown in FIG. 8 include an engine controller 804, a braking control 806, a steering control 808, an accelerator control 810, a clutch control 812, a gas sensor 814, a tire sensor 816, a door lock control 818, a window control 820, an interior lighting control 822, and a radio controller 824. The components shown in FIG. 8 are illustrative of the components in an autonomous vehicle 802. The components shown in FIG. 8 are not intended to be comprehensive. Various embodiments may have additional components.

The engine controller 804 determines the output of the engine, which converts energy into rotation of the wheels of the autonomous vehicle 802. The engine controller 804 may control various actuators in an engine in the autonomous vehicle 802. The function of the actuators may change based on signals received from the autonomous vehicle electrical system 102. The engine controller 804 may also transmit engine data to various components in the autonomous vehicle electrical system 102.

The braking control 806 sends signals to the brakes of the autonomous vehicle 802. The braking control 806 may receive signals from the drive by wire component 602. In the event of a fault in the drive by wire component 602, the braking control 806 may accept signals from a vehicle computer that takes over the functions of the drive by wire component 602. Similarly, the steering control 808 may receive signals from the drive by wire component 602. The steering control 808 sends signals, that when executed, turn the wheels of the autonomous vehicle 802. The accelerator control 810 also receives signals from the drive by wire component 602. The accelerator control 810 sends signals to the engine controller 804, which change the output of the engine. The drive by wire component 602 also transmits signals to the clutch control 812, which sends signals that, when executed, shift the gears for output from the engine. A fault in the drive by wire component 602 may result in the braking control 806, steering control 808, accelerator control 810, and clutch control 812 not receiving input signals that originate from the multitude of autonomous vehicle computers 130.

The gas sensor 814 transmits signals that describe the gas level in an autonomous vehicle 802 with an internal combustion engine. The multitude of autonomous vehicle computers 130 may modify the navigation of the autonomous vehicle 802 based on signals received from the gas sensor 814. The tire sensor 816 reads the tire pressure of a tire on the autonomous vehicle 802. The autonomous vehicle 802 may have a tire sensor 816 for each tire on the autonomous vehicle 802. The tire sensor 816 may transmit the tire pressure wirelessly to a receiver. The receiver for the tire sensor 816 may be connected to a bus in the autonomous vehicle electrical system 102.

The door lock control 818 controls the locking the unlocking of the various doors in the autonomous vehicle 802. Signals sent to the door lock control 818 may be classified as a high priority as the door lock control 818 does not take up high bandwidth and the locking and unlocking of doors in the autonomous vehicle 802 impacts the safety of the autonomous vehicle 802. Like the door lock control 818, the window control 820 may be classified as a high priority because the opening and closing of the windows impacts the safety of the autonomous vehicle 802. The window control 820 sends signals to the autonomous vehicle windows that, when executed, raise and lower the windows.

The interior lighting control 822 sends signals to the lights on the interior of the autonomous vehicle 802 that, when executed, change the state of the lights inside the autonomous vehicle 802. The interior lighting control 822 may be classified as a low priority because the interior lighting of the autonomous vehicle 802 does not impact the drivability of the autonomous vehicle 802 and does not impact the safety of the autonomous vehicle 802. Thus, components of the interior lighting control 822 may be repurposed to perform the functions of faulting components. Similarly, components that control the radio controller 824, may be repurposed to perform the functions of faulting components in the autonomous vehicle 802. The radio controller sends signals to the radio and/or entertainment system of the autonomous vehicle 802 that, when executed, modify the output of the radio/entertainment system.

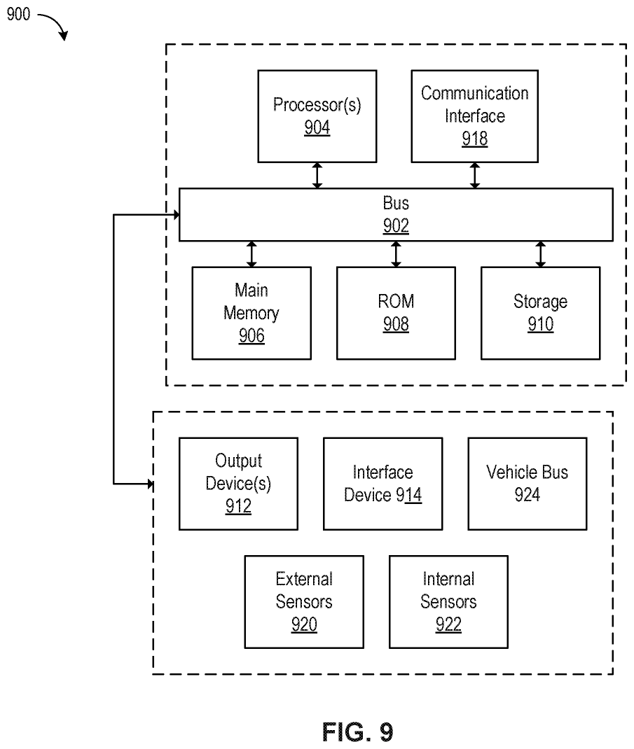

FIG. 9 is a block diagram that illustrates a computer system 900 upon which any embodiments of the autonomous vehicle computers 250 may be implemented. The computer system 900 includes a bus 902 or other communication mechanism for communicating information, one or more hardware processors 904 coupled with bus 902 for processing information. The bus 902 connects the internal components of the computer system 900 and is separate from the vehicle bus 924. The computer system 900 may be connected to one or more vehicle buses 924. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render the computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to an output device 912, such as a cathode ray tube (CRT) or LCD display (or touch screen), for displaying information to a computer user. An interface device 914 including, but not limited to alphanumeric and other keys, a cursor control, or a touchscreen display, is coupled to bus 902 for communicating information and command selections to the processor 904. The interface device 914 may be used by passengers to change the navigating instructions of the autonomous vehicle. The external sensors 920 of the autonomous vehicle may be coupled to the bus to communicate information on the environment outside the autonomous vehicle. The internal sensors 922 may be coupled to the bus 902 to communicate information observable from the inside of the autonomous vehicle.

The computer system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors 904. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 900 may implement the techniques described herein using customized hard-wired logic, one or more ASICs or FPGAs, firmware and/or program logic which in combination with the computer system 900 causes or programs the computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a component control. A component control local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may retrieve and execute the instructions. The instructions received by main memory 906 may optionally be stored on storage device 910 either before or after execution by processor 904.

The computer system 900 also includes a communication interface 918 coupled to bus 902. Communication interface 918 provides a two-way data communication coupling to one or more network links that are connected to one or more local networks. For example, communication interface 918 may be an integrated services digital network (ISDN) card, cable component control, satellite component control, or a component control to provide a data communication connection to a corresponding type of telephone line. As another example, communication interface 918 may be a local area network (LAN) card to provide a data communication connection to a compatible LAN (or WAN component to communicate with a WAN). Wireless links may also be implemented. In any such implementation, communication interface 918 sends and receives electrical, electromagnetic or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP in turn provides data communication services through the world-wide packet data communication network now commonly referred to as the “Internet”. Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution. Each of the processes, methods, and algorithms described in the preceding sections may be embodied in, and fully or partially automated by, code modules executed by one or more computer systems 900 or computer processors 904 comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

The various operations of example methods described herein may be performed, at least partially, by one or more processors 904 that are temporarily configured (e.g., by software) or permanently configured to perform the relevant operations. Similarly, the methods described herein may be at least partially processor-implemented, with a particular processor 904 or processors 904 being an example of hardware. For example, at least some of the operations of a method may be performed by one or more processors 904. Moreover, the one or more processors 904 may also operate to support performance of the relevant operations in a “cloud computing” environment or as a “software as a service” (SaaS). For example, at least some of the operations may be performed by a group of computers (as examples of machines including processors 904), with these operations being accessible via a network (e.g., the Internet) and via one or more appropriate interfaces (e.g., an Application Program Interface (API)).

The performance of certain of the operations may be distributed among the processors 904, not only residing within a single machine, but deployed across a number of machines. In some example embodiments, the processors 904 may be located in a single geographic location (e.g., within a home environment, an office environment, or a server farm). In other example embodiments, the processors 904 may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable the practice of the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A method for implementing a bus protection in an autonomous vehicle: the method comprising:
determining, by a vehicle computer, that there is a fault in a first bus of the autonomous vehicle;
determining a route of communication for one or more components of the autonomous vehicle that are connected to the first bus; and
wherein the route of communication traverses a second bus in the autonomous vehicle.

2. The method of claim 1, further comprising:
determining that there is a fault in a first component of the autonomous vehicle that is connected to the first bus;
determining that one or more functions, of the first component, are not being performed; and
performing, by a second component of the autonomous vehicle, which is connected to the first bus, the one or more functions of the first component.

3. The method of claim 2, further comprising:
creating a priority of functions for the one or more components of the autonomous vehicle that are connected to the first bus; and
selecting the second component based on the priority of functions.

4. The method of claim 3, further comprising:
determining a set of the one or more components that are capable of performing the functions of the first component; and
wherein the second component is selected from the set.

5. The method of claim 4, further comprising determining one or more functions of the second component to stop based on the priority of functions.

6. The method of claim 1, wherein the one or more components of the autonomous vehicle that are connected to the first bus are configured to send and receive signals on the route of communication responsive to the determination of the fault in the first bus.

7. The method of claim 6:
wherein two or more components, that are connected to the first bus, are configured to send and receive signals from each other; and
wherein the signals traverse the route of communication.

8. An autonomous vehicle: the autonomous vehicle comprising:
a vehicle computer that is configured to determine that there is a fault in a first bus of the autonomous vehicle;
the vehicle computer is configured to determine a route of communication for one or more components of the autonomous vehicle that are connected to the first bus; and
wherein the route of communication traverses a second bus in the autonomous vehicle.

9. The autonomous vehicle of claim 8:
wherein the vehicle computer is further configured to determine that there is a fault in a first component of the autonomous vehicle that is connected to the first bus;
wherein the vehicle computer is further configured to determine that one or more functions, of the first component, are not being performed;
further comprising a second component of the autonomous vehicle, which is connected to the first bus; and
wherein the second component is capable of performing the one or more functions of the first component.

10. The autonomous vehicle of claim 9:
wherein the vehicle computer is further configured to create a priority of functions for the one or more components of the autonomous vehicle that are connected to the first bus; and
wherein the vehicle computer is further configured to select the second component based on the priority of functions.

11. The autonomous vehicle of claim 10:
wherein the vehicle computer is further configured to determine a set of the one or more components that are capable of performing the functions of the first component; and
wherein the second component is selected from the set.

12. The autonomous vehicle of claim 11, wherein the vehicle computer is further configured to determine one or more functions of the second component to stop based on the priority of functions.

13. The autonomous vehicle of claim 8, wherein the one or more components of the autonomous vehicle that are connected to the first bus are configured to send and receive signals on the route of communication responsive to the determination of the fault in the first bus.

14. The autonomous vehicle of claim 13:
wherein two or more components, that are connected to the first bus, are configured to send and receive signals from each other; and
wherein the signals traverse the route of communication.

15. A computer readable storage medium in an autonomous vehicle having data stored therein representing a software executable by a computer, the software comprising instructions that, when executed, cause the autonomous vehicle to perform:
determining that there is a fault in a first bus of the autonomous vehicle;
determining a route of communication for one or more components of the autonomous vehicle that are connected to the first bus; and
wherein the route of communication traverses a second bus in the autonomous vehicle.

16. The computer readable storage medium in the autonomous vehicle of claim 15, further comprising:
determining that there is a fault in a first component of the autonomous vehicle that is connected to the first bus;
determining that one or more functions, of the first component, are not being performed; and
performing, by a second component of the autonomous vehicle, which is connected to the first bus, the one or more functions of the first component.

17. The computer readable storage medium in the autonomous vehicle of claim 16, further comprising:
creating a priority of functions for the one or more components of the autonomous vehicle that are connected to the first bus; and
selecting the second component based on the priority of functions.

18. The computer readable storage medium in the autonomous vehicle of claim 17, further comprising:
determining a set of the one or more components that are capable of performing the functions of the first component; and
wherein the second component is selected from the set.

19. The computer readable storage medium in the autonomous vehicle of claim 18, further comprising determining one or more functions of the second component to stop based on the priority of functions.

20. The computer readable storage medium in the autonomous vehicle of claim 15, wherein the one or more components of the autonomous vehicle that are connected to the first bus are configured to send and receive signals on the route of communication responsive to the determination of the fault in the first bus.
